(19) United States
(12) Patent Application Publication
(10) Pub. No.: US 2006/0178032 A1
(43) Pub. Date: Aug. 10, 2006

(54) Connector allowing locking of connected state or non-connected state

(76) Inventors: Osamu Hashiguchi, Tokyo (JP); Kazuki Saito, Tokyo (JP); Toshiaki Ariyoshi, Tochigi (JP); Masahiko Sato, Tochigi (JP)

Correspondence Address: WILLIAM COLLARD;COLLARD & ROE, P.C., 1077 NORTHERN BOULEVARD, ROSLYN, NY, 11576, US

(21) Appl. No.: 10/549,092

(22) PCT Filed: Mar. 12, 2004
(86) PCT No.: PCT/JP04/03277

§ 371 Date: Sep. 13, 2005

(30) Foreign Application Priority Data
Mar. 14, 2003 (JP) 2003-069499

(51) Int. Cl. H01R 4/50

(52) U.S. Cl. 439/342

(57) ABSTRACT

A connector for switching between the states of the connection and non-connection to a mating connector by a cam mechanism (6) movably installed in insulators (2, 3), wherein the cam mechanism comprises a first cam (6a) and a second cam (6b). The first cam is rotatable about an axis, slidable between first and second positions in a direction parallel with the axis, and energized toward the first position by an elastic member (8). The second cam is rotated in conjunction with the first cam to provide either of the connected state and non-connected state according to a rotating angle. The first cam comprises a locked part (6a2) engaged with the lock part (3b3) of the insulator in the rotating direction thereof when positioned at the first position and disengaged from the lock part when positioned at the second position.

### TECHNICAL FIELD

This invention relates to a connector that switches between a connected state and a non-connected state by operation of cams.

### BACKGROUND ART

Connectors called ZIF (Zero Insertion Force) have been conventionally known. Connectors of this type are disclosed, for example, in Japanese Unexamined Patent Application Publication (JP-A) No. 2000-306642 and Japanese Unexamined Patent Application Publication (JP-A) No. 2000-286025. Those connectors each include a rotatable cam and a slider engaging the cam. By rotational operation of the cam, the slider is forced to slide so that switching is performed between a connected state and a non-connected state with respect to a mating connector. This enables connection or disconnection of the connector with an extremely small operating force.

However, when the connector is subjected to shock, vibration, or the like in the connected state, it is expected that the cam may be rotated due to its influence. When the cam is rotated, there is a possibility that the slider may slide to cause switching from the connected state to the non-connected state. Conversely, switching may be caused from the non-connected state to the connected state. In any event, there is a problem that the connected state or the non-connected state of the connector cannot be reliably maintained.

### DISCLOSURE OF THE INVENTION

It is therefore an object of this invention to provide a connector that can reliably maintain a connected state or a non-connected state even when subjected to shock, vibration, or the like.

It is another object of this invention to realize the foregoing object by a mechanism that is easy to operate.

It is still another object of this invention to realize the foregoing object without complicating a structure.

According to an aspect of the present invention, there is provided a connector including an insulator and a cam mechanism movably mounted to said insulator for switching between a connected state and a non-connected state with respect to a mating connector, said connector characterized in that said cam mechanism comprises a first cam that is movable about one axis and slidable between a first and a second position in a predetermined direction parallel to said one axis, a second cam that is rotated in conjunction with said first cam to provide either one of said connected state and said non-connected state in response to a rotation angle thereof, and an elastic member biasing said first cam toward said first position, said insulator includes a locking portion, and said first cam comprises a to-be-locked portion that is engaged with said locking portion in a rotational direction thereof when located at said first position while disengaged from said locking portion when located at said second position.

### BRIEF DESCRIPTION OF THE DRAWINGS

FIG. 1 shows a locking mechanism of a socket connector of one embodiment of this invention, wherein (A) is a rear view, (B) is a plan view, (C) is a front view, and (D) is a side view.

FIG. 2 shows a pin connector for connection to the socket connector, wherein (A) is a front view, (B) is a plan view, and (C) is a side view.

FIG. 3 shows a contact of the socket connector, wherein (A) is a front view, (B) is a side view, (C) is a rear view, and (D) is a bottom view.

FIG. 4 is sectional views each taken along line E-E in FIG. 1, (B), wherein (A) shows a non-connected state before fitting of the pin connector and (B) shows a connected state after fitting of the pin connector.

FIG. 5 is enlarged sectional views of the main part before and after the socket connector and the pin connector are fitted together, wherein (A) shows the state before the fitting and before sliding of an actuator and (B) shows the state after the fitting and after sliding of the actuator.

FIG. 6 shows the locking mechanism of the socket connector, wherein (A) is a plan view of the non-connected state (open position), (B) is a sectional view taken along line A-A in (A), (C) is a sectional view of the state where an upper cam is pushed into a cover in (B), (D) is a plan view of the connected state (closed position), (E) is a sectional view taken along line B-B in (D), and (F) is a sectional view of the state where the upper cam is restored in (E).

FIG. 7 is enlarged sectional views each taken along line C-C or line D-D in FIG. 6, (B), wherein (A) shows the state taken along line C-C (but, the upper cam not illustrated), (B) shows the non-connected state taken along line C-C, (C) shows the connected state taken along line C-C, and (D) shows the state taken along line D-D.

### BEST MODE FOR CARRYING OUT THE INVENTION

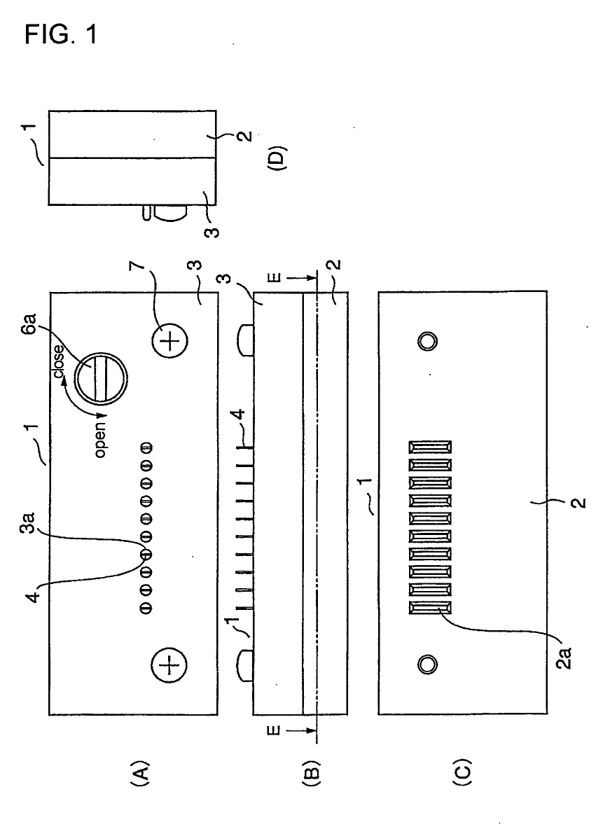

Referring to FIGS. 1 to 7, description will be made about a connector according to an embodiment of this invention.

In FIGS. 1, 4, and 6, a connector 1 is a socket connector which is generally called a ZIF connector. The socket connector 1 comprises an insulating case 2, an insulating cover 3 covering the case 2, and conductive socket contacts 4 retained by the cover 3. The case 2 and the cover 3 are fixed together by a pair of screws 7. The socket contacts 4 have tip portions that are respectively exposed through a plurality of projection holes 3a provided in the cover 3. The case 2 is provided with a plurality of insertion holes 2a for inserting a plurality of pin contacts of a pin connector. Herein, the case 2 and the cover 3 are collectively called an insulator.

An insulating actuator 5 is slidably mounted in the case 2. The actuator 5 is caused to slide by operation of a cam mechanism 6. The cam mechanism 6 comprises a first cam, i.e. an upper cam 6a, that is rotatable and insulative and a second cam, i.e. a lower cam 6b, that is insulative and moves in conjunction with the upper cam 6a. A cylindrical compression coil spring 8 is interposed between the upper cam 6a and the lower cam 6b as an elastic member. The upper cam 6a is rotatable about one axis and slidable between first and second positions in a predetermined direction parallel to such one axis. As will be described later, the lower cam 6b is engaged with the upper cam 6a so as to be rotated in conjunction with the upper cam 6a.

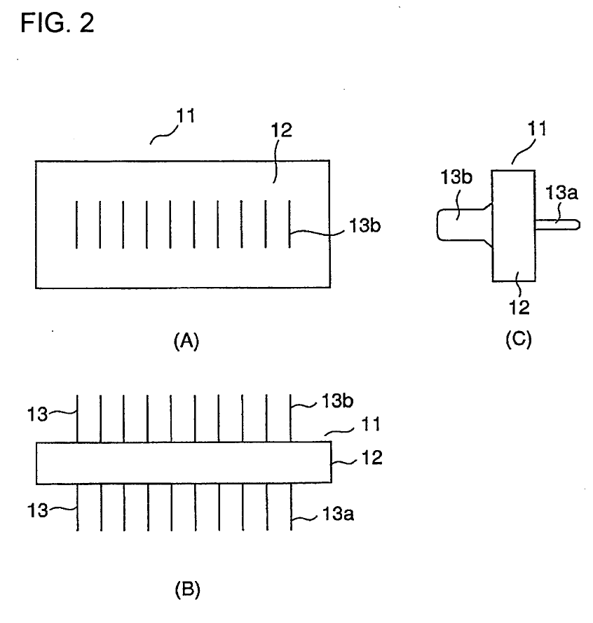

FIG. 2 shows a pin connector 11 as a mating connector to be connected to the socket connector 1. The pin connector 11 comprises an insulator 12 and a plurality of pin contacts 13 retained by the insulator 12. Each pin contact 13 has a pin-shaped terminal 13a projecting from one side of the insulator 12 for connection to a printed board and a thin plate-shaped pin 13b projecting from the other side of the insulator 12 for connection to the socket contact 4.

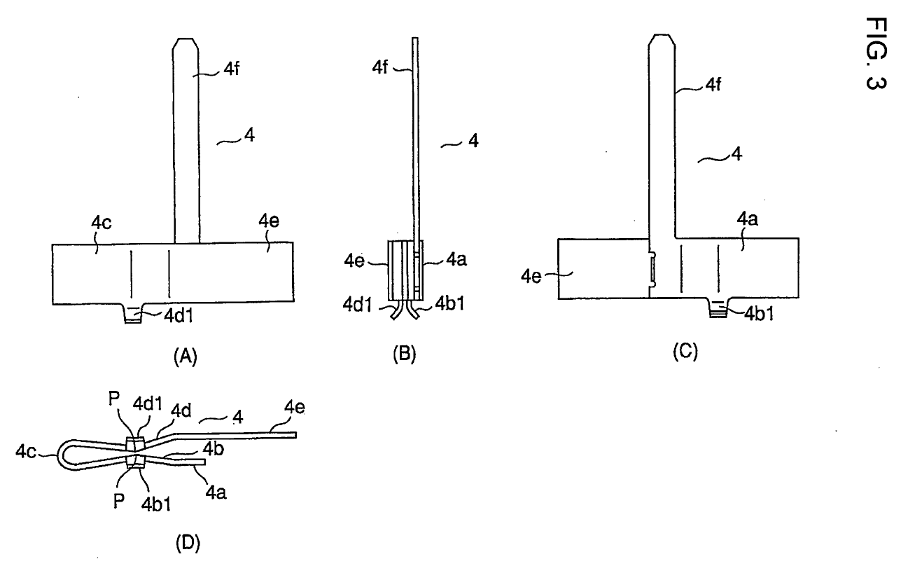

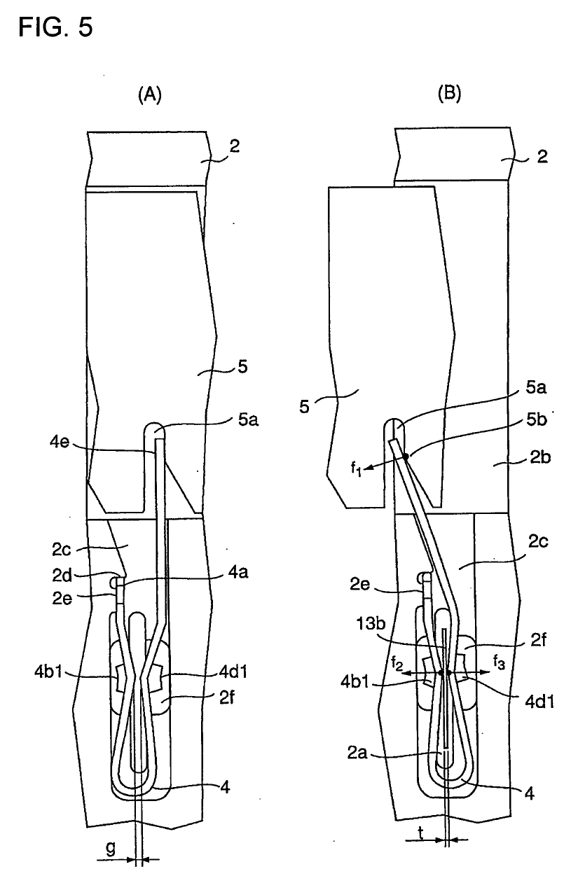

In FIGS. 3 and 5, each socket contact 4 is formed integral and continuous so as to have a stationary portion 4a to be fixed to the case 2, a bent portion 4b bent at a first contact point P, a generally U-shaped portion 4c, a bent portion 4d bent at a second contact point P, a movable portion 4e to be pushed by the actuator 5, and a terminal portion 4f projecting from the stationary portion 4a. The first contact point P and the second contact point P face each other so as to provide a gap therebetween. On the outer sides of the first contact P and the second contact point P, guides 4b1 and 4d1 are symmetrically provided, respectively. The guides 4b1 and 4d1 serve to introduce the pin 13b of the corresponding pin contact 13 into the gap between the contact points P so that the pin 13b contacts the contact points P with no insertion force without buckling that is generated due to interference of the pin 13b with the corresponding socket contact 4.

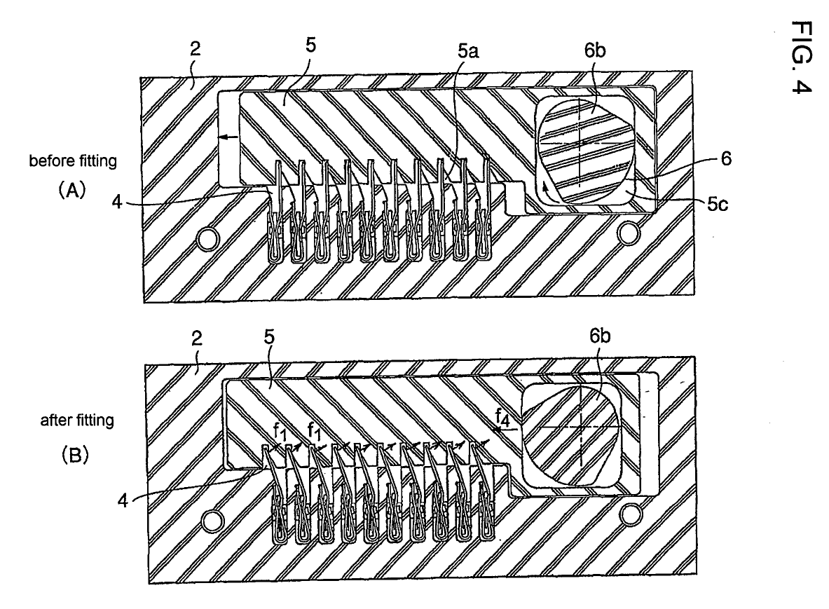

When the lower cam 6b rotates in an arrow direction in FIG. 4, (A), the actuator 5 slides in an arrow direction to a position shown in FIG. 4, (B). In this event, the actuator 5 displaces the movable portions 4e of the socket contacts 4. That is, the actuator 5 slides following the rotation of the lower cam 6b to drive the socket contacts 4, thereby performing switching between a connected state and a non-connected state of the socket connector 1 and the pin connector 11. Therefore, as will be clear from later description, the contact points P implement a ZIF function of sandwiching under pressure the pin 13b of each pin contact 13.

In FIG. 5, (A), a great part of each socket contact 4 is received in a contact groove 2c. A forward end and a side surface of the stationary portion 4a are in abutment with a stopper 2d and a fixing wall 2e of the case 2, respectively. The movable portion 4e is received in a driving groove 5a of the actuator 5. The guides 4b1 and 4d1 are received in a guide groove 2f of the case 2. Herein, the gap g between the contact points P is designed to be greater than a thickness t of the pin 13b.

In the case where the pin connector 11 is connected to the socket connector 1, when the actuator 5 slides from a position in FIG. 5, (A) to a position in FIG. 5, (B), the upper cam 6a and the lower cam 6b rotate to the right in conjunction therewith (see FIG. 1, (A) and FIG. 4, (A)). Since the movable portion 4e of each socket contact 4 receives a force f₁ from a corner 5b of an inclined surface of the driving groove 5a of the actuator 5, the socket contact 4 is elastically deformed. In this event, the side surface of the stationary portion 4a receives a reaction force from the fixing wall 2e of the case 2 and therefore the contact points P receive forces f₂ and f₃ from both surfaces of the pin 13b of the pin connector 11 while sandwiching it therebetween under pressure.

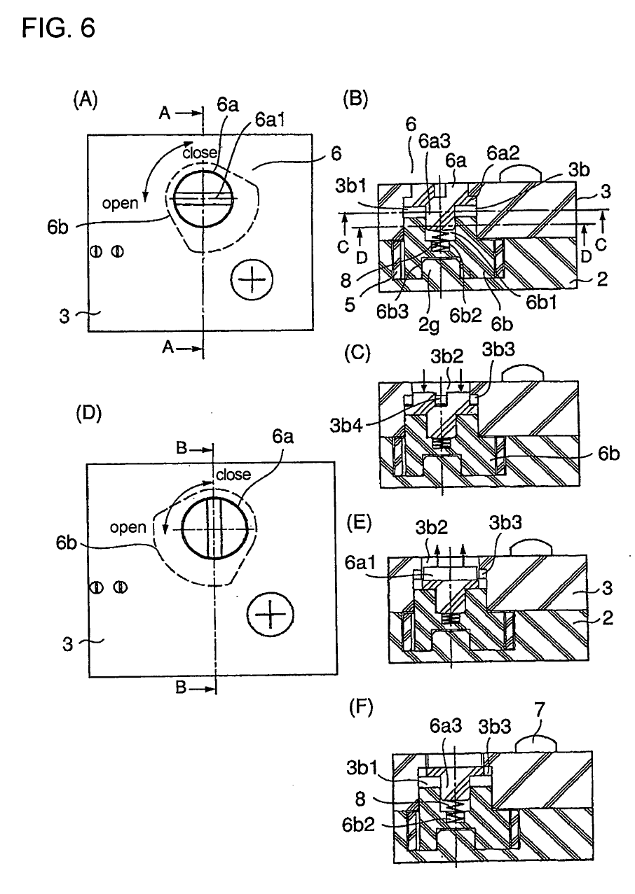

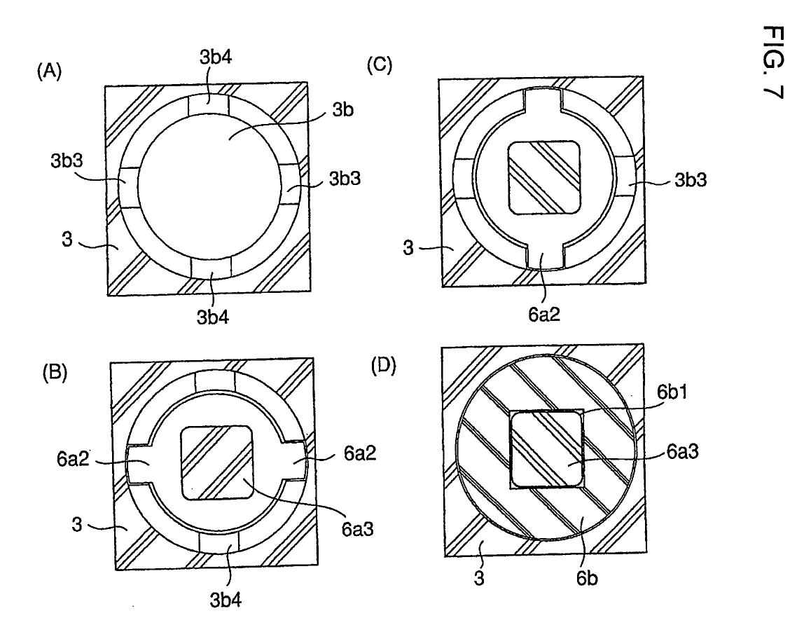

The socket connector 1 has a locking mechanism capable of locking the operation of the cam mechanism 6. Referring to FIGS. 6 and 7, the locking mechanism will be described.

As shown in FIG. 6, (A) and (B), the upper cam 6a basically has a circular shape in cross-section. In the upper part of a circular cam insertion hole 3b provided in the cover 3, the upper cam 6a is mounted so as to be rotatable by 90° between an open position and a closed position. The upper cam 6a has a linear groove, i.e. a minus groove 6a1, at one end in the foregoing predetermined direction, i.e. on the surface operable from the exterior, a pair of to-be-locked bosses 6a2 at peripheral symmetrical positions, and an angular boss 6a3 at the other end in the predetermined direction, i.e. on the back side. The minus groove 6a1 enables rotational operation of the upper cam 6a by the use of a so-called minus driver. The to-be-locked bosses 6a2 project radially outward and are collectively called a to-be-locked portion herein. The angular boss 6a3 has a square shape in cross-section.

The lower cam 6b is disposed so as to face the upper cam 6a in the predetermined direction and retained by the case 2 and the cover 3 so as to be rotatable by 90° about the foregoing one axis. The lower cam 6b has an angular hole 6b1 on an upper surface thereof, a spring receiving hole 6b2 continuous with the angular hole 6b1, and a rotation center hole 6b3 on a lower surface thereof.

The angular boss 6a3 of the upper cam 6a is fitted into the angular hole 6b1 of the lower cam 6b so as to be slidable in the foregoing predetermined direction. Naturally, because of the fitting between the angular boss 6a3 and the angular hole 6b1, the upper cam 6a and the lower cam 6b are engaged with each other in the rotational direction so as to rotate in conjunction with each other.

In order to allow vertical movement of the upper cam 6a, the cam insertion hole 3b of the cover 3 is provided with clearances 3b1 and 3b2. Further, as shown in FIG. 7, (A), the cam insertion hole 3b is provided with a pair of locking boss grooves 3b3 for engagement with the pair of to-be-locked bosses 6a2 of the upper cam 6a at the open position (before fitting) and a pair of locking boss grooves 3b4 for engagement therewith at the closed position (after fitting). The pair of to-be-locked bosses 6a2 differ in phase by 180° while the two pairs of locking boss grooves 3b3 and 3b4 differ in phase by 90°. These locking boss grooves 3b3 and 3b4 extend in radial directions and are collectively called a locking portion herein.

The case 2 is provided with an actuator insertion hole 2b (see FIG. 5, (B)) for allowing the actuator 5 to slide. The actuator 5 is provided with a lower-cam insertion hole 5c (see FIG. 4, (A)) for allowing the lower cam 6b to rotate. Further, the case 2 is provided with a support shaft 2g for receiving the rotation center hole 6b3 of the lower cam 6b fitted therearound.

Now, description will be made about the operation of the locking mechanism.

In FIG. 6, (A) and (B) and FIG. 7, (B), the pair of to-be-locked bosses 6a2 are inserted in the pair of locking boss grooves 3b3 of the cover 3. In this state, the upper cam 6a is stopped from rotation so as to be locked. In this event, the socket connector 1 and the pin connector 11 are in the non-connected state. Since the upper cam 6a is locked, the non-connected state is reliably maintained.

For switching from the non-connected state to the connected state, the minus driver (not illustrated) is first inserted into the minus groove 6a1 of the upper cam 6a and pushes the upper cam 6a to the inside of the cam insertion hole 3b of the cover 3. Then, the upper cam 6a causes compression of the compression coil spring 8 to reach the state of FIG. 6, (C). Therefore, the pair of to-be-locked bosses 6a2 are released from the locking engagement with the pair of locking boss grooves 3b3 of the cover 3. In other words, the to-be-locked bosses 6a2 escape from the locking boss grooves 3b3.

Then, when the upper cam 6a is rotated to the right by 90°, the upper cam 6a reaches the state of FIG. 6, (D) and (E) and FIG. 7, (C). In this event, since the angular boss 6a3 of the upper cam 6a and the angular hole 6b1 of the lower cam 6b are fitted together as shown in FIG. 7, (D), the lower cam 6b is also rotated to the right by 90°. Therefore, as shown in FIG. 4, (A), the lower cam 6b causes the actuator 5 to slide in the arrow direction to thereby achieve the state shown in FIG. 4, (B) so that the socket connector 1 and the pin connector 11 are placed in the connected state. In this connected state, the lower cam 6b exerts an action of a force f₄ to the actuator 5 while the actuator 5 receives a reaction of the force f₁ from each socket contact 4.

Subsequently, when the minus driver is removed from the minus groove 6a1 of the upper cam 6a, the upper cam 6a reaches the state shown in FIG. 6, (F) due to a restoring force of the compression coil spring 8. In this event, the pair of to-be-locked bosses 6a2 enter the pair of locking boss grooves 3b4 of the cover 3. Therefore, the upper cam 6a is stopped from rotation so as to be locked and, as a result, the connected state is reliably maintained.

Although the case 2 and the cover 3 are in the form of the separate components in this embodiment, it is possible to change the design so that they are formed as a single component.

1. A connector including an insulator and a cam mechanism movably mounted to said insulator for switching between a connected state and a non-connected state with respect to a mating connector, said connector wherein said cam mechanism comprises a first cam that is movable about one axis and slidable between a first and a second position in a predetermined direction parallel to said one axis, a second cam that is rotated in conjunction with said first cam to provide either one of said connected state and said non-connected state in response to a rotation angle thereof, and an elastic member biasing said first cam toward said first position, said insulator includes a locking portion, and said first cam comprises a to-be-locked portion that is engaged with said locking portion in a rotational direction thereof when located at said first position while disengaged from said locking portion when located at said second position.

2. The connector according to claim 1, wherein said locking portion comprises two pairs of locking boss grooves that differ in phase by 90° and said to-be-locked portion comprises a pair of to-be-locked bosses that differ in phase by 180° and are selectively fitted into either one of said two pairs of locking boss grooves.

3. The connector according to claim 1, wherein said first cam comprises an angular boss extending in said predetermined direction along said one axis and said second cam comprises an angular hole that is rotatable about said one axis and fitted around said angular boss so as to be engaged with said angular boss in a rotational direction thereof.

4. The connector according to claim 3, wherein said elastic member comprises a compression coil spring disposed in said angular hole.

5. The connector according to claim 4, wherein said second cam has a spring receiving hole at the bottom of said angular hole and said compression coil spring has one end disposed in said spring receiving hole and the other end contacting said angular boss.

6. The connector according to claim 5, wherein said spring receiving hole has a circular shape in section.

7. The connector according to claim 1, wherein said first cam has a surface at one end in said predetermined direction, said surface operable from the exterior of said insulator.

8. The connector according to claim 7, wherein said surface has a linear groove.

9. The connector according to claim 1, further comprising conductive contacts retained by said insulator, wherein said connected state is obtained when said contacts are brought into contact with said mating connector while said non-connected state is obtained when said contacts are separated from said mating connector.

10. The connector according to claim 1, further comprising an actuator slidably retained by said insulator and engaged with said second cam and said contacts, wherein said actuator slides to drive said contacts following rotation of said second cam, thereby switching between said connected state and said non-connected state.
